(19) United States
(12) Patent Application Publication
(10) Pub. No.: US 2021/0110816 A1
(43) Pub. Date: Apr. 15, 2021

(54) ELECTRONIC APPARATUS AND METHOD OF PROVIDING SENTENCE THEREOF

(71) Applicant: Samsung Electronics Co., Ltd., Suwon-si (KR)

(72) Inventors: Hyungtak CHOI, Suwon-si (KR); Lohit RAVURU, Suwon-si (KR); Siddarth K M, Seoul (KR); Hojung LEE, Suwon-si (KR); Seungsoo KANG, Suwon-si (KR); Hyunwoo PARK, Suwon-si (KR); Eunho LEE, Seoul (KR)

(21) Appl. No.: 17/069,291

(22) Filed: Oct. 13, 2020

(30) Foreign Application Priority Data
Oct. 14, 2019 (KR) 10-2019-0126781

(51) Int. Cl. G10L 15/18; G10L 15/05; G10L 15/06; G10L 15/22

(52) U.S. Cl. CPC G10L 15/1822; G10L 15/05; G10L 2015/227; G10L 15/22; G10L 15/063

(57) ABSTRACT

An electronic apparatus is provided. The electronic apparatus includes a memory storing a module configured to provide a synonym for at least one word included in an input sentence and a processor configured to generate, based on a sentence including a plurality of words being input, at least one paraphrase sentence for the input sentence using the module, select a second word related to a first word among a plurality of words included in the input sentence, obtain a synonym for the second word using the module, and generate the paraphrase sentence based on a synonym for the first word and the second word.

### CROSS-REFERENCE TO RELATED APPLICATION(S)

This application is based on and claims priority under 35 U.S.C. § 119(a) of a Korean patent application number 10-2019-0126781, filed on Oct. 14, 2019, in the Korean Intellectual Property Office, the disclosure of which is incorporated by reference herein in its entirety.

### BACKGROUND

### 1. Field

The disclosure relates to an electronic apparatus and a method of providing a sentence thereof. More particularly, the disclosure relates to an electronic apparatus providing a sentence having a same intent as an intent of an input sentence and a method of providing the sentence.

### 2. Description of Related Art

Recently, natural language processing technology has been developed by the development of artificial intelligence (AI) technology. Specifically, a technology for providing a natural language for a person to understand a response thereto is gradually developed by analyzing and understanding the intent of a natural language used by a user by using an AI model learned by an electronic apparatus.

The natural language processing is widely used in a dialogue system such as voice recognition, machine translation, chatbot, or the like, and a process of learning various sentences is required to facilitate natural language processing by an electronic apparatus.

In the related art, in a process of learning various sentences by an electronic apparatus, there is an inconvenience that a user should provide various sentences having the same intent to the electronic apparatus.

Accordingly, there is an increasing interest in the art of creating a paraphrase sentence for one sentence in order to reduce inconvenience a user may feel when the user creates multiple sentences of the same intent. However, it is not easy for an electronic apparatus to create various forms of sentences (diversity) while having the same intent for one sentence (intent preservation).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus for generating and providing a plurality of sentences having a same intent as an input sentence using an artificial intelligence model and a method of providing a sentence thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a memory storing a module configured to provide a synonym for at least one word included in an input sentence and a processor configured to, based on a sentence including a plurality of words being input, generate at least one paraphrase sentence for the input sentence using the module, select a second word related to a first word among a plurality of words included in the input sentence, obtain a synonym for the second word using the module, and generate the paraphrase sentence based on a synonym for the first word and the second word.

The memory may include a database comprising a plurality of words, and the processor may, based on receiving a user input to select at least one word among a plurality of words included in the input sentence as a first word, select a second word combinable with the first word based on an intent of the input sentence, and obtain a synonym for the second word using the module from the database stored in the memory.

The processor may obtain a vector value of the second word, and obtain a synonym for the second word among words stored in the database based on the obtained vector value.

The processor may search a plurality of candidate words combinable with the first word based on an intent of the input sentence, identify a degree of matching between the first word and the candidate word based on an attention distribution, and select the second word based on the degree of matching.

The processor may, based on receiving a user input to select at least one of the generated paraphrase sentences, store the selected sentence in relation to the input sentence in the memory.

The electronic apparatus according to an embodiment may further include a display, and the processor may display the input sentence, and based on one of a plurality of words included in the input sentence being selected as a first word, control the display to display a plurality of menus for the selected first word, based on a first menu among the plurality of menus being selected, provide a paraphrase sentence including a word with a same text as the selected first word, and based on a second menu among the plurality of menus being selected, provide a paraphrase sentence including a word with a same intent as the selected first word.

The processor may control the display to display a word corresponding to the selected first word, among the plurality of words included in the provided paraphrase sentences, to be differentiated from another word.

In accordance with another aspect of the disclosure, a method of providing a sentence of an electronic apparatus is provided. The method includes receiving a sentence including a plurality of words, selecting a second word related to a first word among a plurality of words included in the input sentence, obtaining a synonym for the second word using a module configured to provide a synonym for at least one word, and generating a paraphrase sentence corresponding to the input sentence based on a synonym for the first word and the second word.

The method may further include receiving a user input to select at least one word among a plurality of words included in the input sentence as a first word. The selecting of the second word may include selecting the second word combinable with the first word based on an intent of the input sentence, and the obtaining of a synonym for the second word may include obtaining a synonym for the second word using the module from a database including a plurality of words.

The obtaining of a synonym for the second word may include obtaining a vector value of the second word, and obtaining a synonym for the second word among words stored in the database based on the obtained vector value.

The selecting of the second word may include searching a plurality of candidate words combinable with the first word based on an intent of the input sentence, identifying a degree of matching between the first word and the candidate word based on an attention distribution, and selecting the second word based on the degree of matching.

The method may include receiving a user input to select at least one of the generated paraphrase sentences, and storing the selected sentence in relation to the input sentence.

The method may further include displaying the input sentence, based on one of a plurality of words included in the input sentence being selected as a first word, displaying a plurality of menus for the selected first word, based on a first menu among the plurality of menus being selected, providing a paraphrase sentence including a word with a same text as the selected first word, and based on a second menu among the plurality of menus being selected, providing a paraphrase sentence including a word with a same intent as the selected first word.

The method may further include displaying a word corresponding to the selected first word, among the plurality of words included in the provided paraphrase sentence, to be differentiated from another word.

In accordance with another embodiment, a computer readable medium is provided. The computer readable medium stores a program to execute a method of providing a sentence of an electronic apparatus, wherein the method for providing a sentence may include receiving a sentence including a plurality of words, selecting a second word related to a first word among a plurality of words included in the input sentence, obtaining a synonym for the second word using a module configured to provide a synonym for at least one word, and generating a paraphrase sentence corresponding to the input sentence based on a synonym for the first word and the second word.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an electronic apparatus according to an embodiment of the disclosure;

FIG. 2 is a block diagram illustrating a configuration of an electronic apparatus according to an embodiment of the disclosure;

FIG. 3 is a diagram illustrating a relation among a plurality of words stored in database according to an embodiment of the disclosure;

FIG. 4 is a diagram illustrating an artificial intelligence model included in an electronic apparatus according to an embodiment of the disclosure;

FIG. 5 is a block diagram illustrating a configuration of an electronic apparatus according to an embodiment of the disclosure;

FIG. 6 is a diagram illustrating an electronic apparatus according to an embodiment of the disclosure;

FIG. 7 is a diagram illustrating an electronic apparatus according to an embodiment of the disclosure;

FIG. 8 is a diagram illustrating an electronic apparatus according to an embodiment of the disclosure; and

FIG. 9 is a flowchart illustrating a method for providing a sentence of an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this document, the expressions “have,” “may have,” “including,” or “may include” may be used to denote the presence of a feature (e.g., a numerical value, a function, an operation, or a component such as a part), and does not exclude the presence of additional features.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B together.

The terms such as “first,” “second,” and so on may be used to describe a variety of elements, but the elements may not be limited by these terms regardless of order and/or importance. The terms are labels used only for the purpose of distinguishing one element from another.

It is to be understood that an element (e.g., a first element) is “operatively or communicatively coupled with/to” another element (e.g., a second element) is that any such element may be directly connected to the other element or may be connected via another element (e.g., a third element). On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of.” The expression “configured to” does not necessarily mean “specifically designed to” in a hardware sense. Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

In this disclosure, the term user may refer to a person or an apparatus using an electronic apparatus (e.g., an artificial intelligence electronic apparatus).

An electronic apparatus may include at least one of a smart phone, a tablet personal computer (PC), a mobile phone, a video phone, an e-book reader, a desktop PC, a laptop PC, a network computer, a kiosk, a workstation or a server. The electronic apparatus in the disclosure is not limited to a specific device, and any electronic apparatus capable of performing the operation of the disclosure can be the electronic apparatus of the disclosure.

The disclosure will be described in greater detail with reference to the drawings.

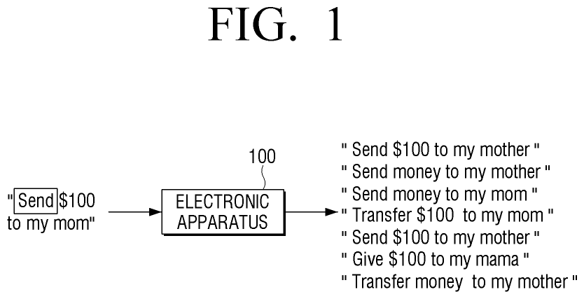

FIG. 1 is a diagram illustrating an electronic apparatus according to an embodiment of the disclosure.

Referring to FIG. 1, an electronic apparatus 100 may obtain at least one sentence. The electronic apparatus 100 may receive a sentence directly from a user, or may receive a sentence from another electronic apparatus (not shown). In the disclosure, data about a sentence which the electronic apparatus 100 obtains from a user or another electronic apparatus (not shown) is denoted as an input sentence. The input sentence may include a plurality of words.

The electronic apparatus 100 may grasp an intent of the input sentence using the AI model and provide a plurality of sentences having the same intent as the input sentence. For example, as shown in FIG. 1, if the sentence “send $100 to my mom” is input to the electronic apparatus 100, the electronic apparatus 100 may understand that the intent of the input sentence is to send money to mom using the AI model, and may provide a plurality of sentences having the same intent such as “Send $100 to my mother,” “Send money to my mom,” “Transfer $100 to my mom” or the like.

The electronic apparatus 100 may directly provide a user with a plurality of sentences having the same intent as the input sentence, or may transmit a sentence to another electronic apparatus (not shown) so that another electronic apparatus (not shown) displays a plurality of sentences.

One of a plurality of words included in the input sentence may be selected by a user. For example, among a plurality of words such as “send,” “$100,” “to,” “my,” and “mom” included in “Send $100 to my mom,” the word “send” might be selected by the user.

In this example, the electronic apparatus 100 may provide a plurality of sentences including words of the same intent as the words selected in the input sentence, based on the intent of the input sentence. For example, if the selected word is “send,” the electronic apparatus 100 may search “send,” “give,” “transfer,” or the like, as a word having the same intent as “send” from a database considering that the input sentence has the intent (or intention) of “send money to mom,” and provide a sentence that includes one of the retrieved words.

The electronic apparatus 100 may select a word having the same intent for each of the remaining words except the selected word among the plurality of words included in the input sentence, considering the intent of the input sentence. The electronic apparatus 100 may combine the selected words to provide a sentence having the same intent as the input sentence.

The electronic apparatus according to the disclosure will be described in greater detail below.

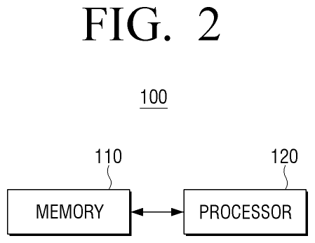

FIG. 2 is a block diagram illustrating a configuration of an electronic apparatus according to an embodiment of the disclosure.

Referring to FIG. 2, the electronic apparatus 100 according to an embodiment includes a memory 110 and a processor 120.

The memory 110 may store a command or data related to at least one other elements of the electronic apparatus 100. The memory 110 may be implemented as a non-volatile memory, a volatile memory, a flash memory, a hard disk drive (HDD), a solid state drive (SSD), or the like. The memory 110 is accessed by the processor 120 and reading, writing, modifying, deleting, or updating of data by the processor 120 may be performed. In the disclosure, the term memory may include the memory 110, read-only memory (ROM) in the processor 120, random access memory (RAM), or a memory card (for example, a micro secure digital (SD) card, and a memory stick) mounted to the electronic apparatus 100. The memory 110 may store a program and data, or the like, to configure various screens to be displayed on a display region of a display.

The memory 110 may store at least one instruction associated with the electronic apparatus 100. The memory 110 may store various software modules for operating the electronic apparatus 100 according to various embodiments.

At least one artificial intelligence (AI) model among the AI model according to various embodiments of the disclosure may be implemented in a software module and stored in the memory 110. Specifically, the memory 110 may be stored with a learned AI model to generate sentences having the same intent as the input sentence. The AI model may include an encoder for generating a potential variable for a sentence and a decoder for providing synonyms for a particular word using a potential variable. The memory 110 may be stored with an encoder that generates a potential variable for the sentence and a decoder that provides synonyms for a particular word using a potential variable. The memory 110 may store a software module configured to provide synonyms for at least one word included in the input sentence.

An AI model is made through learning. Here, being made through learning may refer to a predetermined operating rule or AI model set to perform a desired feature (or purpose) is made by making a basic AI model trained using various training data using a learning algorithm. The learning may be accomplished through a separate server and/or system, but is not limited thereto and may be implemented in an electronic apparatus. Examples of learning algorithms include, but are not limited to, supervised learning, unsupervised learning, semi-supervised learning, or reinforcement learning.

The memory 110 may be stored with a database including a plurality of words and word information such that the AI model may obtain words having the same intent as the plurality of words of the input sentence. The word information included in the database may include a vector value for the word. Here, the vector value is a numerical value of each word as a vector, and as the vector value is similar, it may be identified that the vector value is semantically similar.

The processor 120 may train the AI model and store the trained (or learned) AI model in the memory 110. The processor 120 may determine an operation to perform according to a condition based on the trained AI model.

The AI model may be constructed considering the application field, the purpose of learning, or the computer performance of the device. The AI model may be, for example, a model based on a neural network.

The AI model may include a plurality of weighted network nodes that simulate a neuron of a human neural network. The plurality of network nodes may each establish a connection relation so that the neurons simulate synaptic activity of transmitting and receiving signals through synapses. For example, the AI model may include a neural network model or a deep learning model developed from a neural network model. In the deep learning model, a plurality of network nodes is located at different depths (or layers) and may exchange data according to a convolution connection.

For example, models such as deep neural network (DNN), recurrent neural network (RNN), and bidirectional recurrent deep neural network (BRDNN) may be used as data recognition models, but are not limited thereto.

A function related to the AI may operate through the processor 120 and the memory 110. The processor 120 may comprise one or a plurality of processors. The processor 120 may be a general-purpose processor such as a CPU, an AP, a digital signal processor (DSP), a dedicated processor, or the like, a graphics-only processor such as a graphics processor (GPU), a vision processing unit (VPU), an AI-only processor such as a neural network processor (NPU), or the like, but the processor is not limited thereto. The processor 120 may control processing of the input data according to a predefined operating rule or AI model stored in the memory. If the processor 120 is an AI-only processor, the processor 120 may be designed with a hardware structure specialized for the processing of a particular AI model.

The processor 120 may be electrically connected to the memory 110 to control the overall operation and functionality of the electronic apparatus 100. The processor 120 may execute at least one instruction included in the memory 110 to control the overall operation and functionality of the electronic apparatus 100. For example, the processor 120 may drive an operating system or application program to control hardware or software components connected to the processor 120, and may perform various data processing and operations. The processor 120 may also load and process instructions or data received from at least one of the other components into volatile memory and store the various data in non-volatile memory.

For this purpose, the processor 120 may be implemented with a general-purpose processor (e.g., a CPU or AP) capable of performing the operations by executing one or more software programs stored in a dedicated processor (e.g., embedded processor) or a memory device for performing the operations.

The processor 120 may receive an input sentence that includes a plurality of words. Here, the input sentence may be sentence data directly input from a user through a user interface, or sentence data received from another electronic apparatus (not shown). One of the plurality of words included in the input sentence may be a word selected by the user, and the processor 120 may obtain an input sentence that includes information about the selected word.

When a sentence including a plurality of words is input, the processor 120 may generate at least one paraphrase sentence for the input sentence using a module configured to provide the synonym stored in the memory 110.

The processor 120 may generate potential variables for the input sentence by executing the encoder. The potential variables for the input sentence correspond to a hidden state of the encoder, and may be represented as a probability value including a feature of the input sentence.

The processor 120 may generate a paraphrase sentence for the input sentence using a plurality of words obtained from the decoder.

The processor 120 may generate attention distribution including weights of each of the plurality of words included in the input sentence by executing a decoder. The attention distribution may be a criterion indicating to which word an attention should be paid among a plurality of words included in the input sentence at each time operation outputting a word by the decoder in an intuitive manner.

The processor 120 may select a first word to be included in the paraphrase sentence. The first word may be a word selected by the encoder and the decoder as a word included in the paraphrase sentence. Alternatively, the first word may be a word selected by the user's selection.

When a user input to select one of a plurality of words included in the input sentence is received, at least one word having the same intent as the word selected by the user may be selected, and the first word may be selected from at least one word based on the intent of the input sentence.

If a second word that follows the first word and is combinable with the first word is to be selected in a state where the first word is selected as a word to be included in the paraphrase sentence, the processor 120 may select the second word subsequent to the first word using the attention distribution. For example, in a state in which “$100” is selected as the first word to be included in the paraphrase sentence, the processor 120 may identify that the probability that “to my mother” will be included among the words included in the input sentence is higher than the probability that “send” will be included, based on the attention distribution, and may select “to my mother” as the second word or text that is subsequent to the first word.

The processor 120 may search a plurality of words having the same intent as the second word that may be subsequent, and may obtain the synonyms for the second word among the plurality of searched words from the database. For example, the processor 120 may search “to my mom,” “to my mommy,” etc. as a plurality of words having the same intent as “to my mother,” and may obtain the synonyms of the second word among the plurality of searched words.

The processor 120 may generate a paraphrase sentence based on synonyms for the first word and the second word. Specifically, the processor 120 may combine the synonyms of the first word and the second word to generate a paraphrase sentence.

The processor 120, based on obtaining the input sentence, may convert each of a plurality of words included in the sentence obtained through a word embedding algorithm, which is an AI algorithm, into a vector. The processor 120 may use an AI model, such as a neural net language model (NNLM), recurrent net language model (RNNLM), a continuous bag-of-words (CBOW) model, a skip-gram model, a skip-gram with negative sampling (SGNS) model, or the like, to convert a word into a vector.

The processor 120 may perform natural language processing on the obtained input sentence to determine the intent of the input sentence. Here, the intent of an input sentence may include an intention of a user who has entered an input sentence.

The processor 120 may obtain a domain, an intent, an entity (or parameter, slot, or the like) required to express the intent of the input sentence using a natural language understanding (NLU) module.

The processor 120 may determine the intent of the input sentence and the entity of each word included in the input sentence using a matching rule that is divided into the domain, intent and the entity required to identify the intent through the natural language understanding module (not illustrated). For example, one domain (e.g., a message) may include a plurality of intentions (e.g., message transmission, message deletion, etc.), and one intent may include multiple entities (e.g., transmission objects, transmission times, transmission content, etc.). For example, the domain may be a message if there is a sentence “Please send a message to meet at 7 pm to A at 1 pm,” the domain may be a message, the intent may be a message transmission, and the entity may be a transmission object A, a transmission content (see you at 7 pm), and a transmission time (at 1 pm).

The processor 120 may determine the intent of a word included in the input sentence using a natural language understanding module (not shown), and match the identified intent of the word to the domain and the intention to determine the intention of the user who has entered the input sentence for the input sentence or the intent of the input sentence. For example, the processor 120 may use a natural language understanding module to calculate how many words that are included in the user sentence are included in each domain and intent to determine the intention of the user to be performed or the intent of the input sentence. The processor 120 may also determine the entity of each word included in the input sentence using an underlying word to determine the intent of the user or the intent of the input sentence.

Based on receiving an input of a user selecting a word among a plurality of words included in the input sentence, the processor 120 may select a second word that is combinable with the first word based on the intent of the input sentence, and select at least one word having the same intent as the second word from the database.

For this purpose, the processor 120 may obtain a vector value corresponding to the second word and select at least one word among the words stored in the database based on the obtained vector value. The at least one word selected from the database may be a synonym for the second word. That is, the word may include words of the same or similar intent as the selected word, and the at least one word selected from the database may include at least one of a word that has the same text as the selected word and a word that has a different text but has a same intent as the selected word.

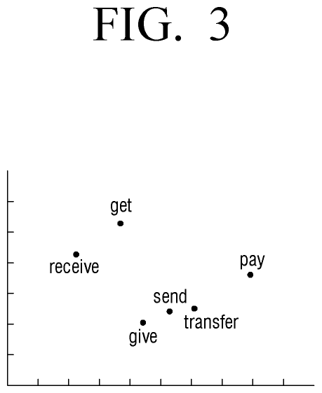

FIG. 3 is a diagram illustrating a relation among a plurality of words stored in the database according to an embodiment of the disclosure.

The words included in the database may be converted to vector values through a word embedding algorithm. The word embedding is a well-known technique, and thus a detailed description thereof will be omitted.

The similarity between words included in the database may be identified using cosine similarity. The cosine similarity is a value measured using a cosign value of an angel between the two vectors in the internal space and may denote a degree of similarity between vectors. As the cosine similarity value approaches 1, the similarity between the two vectors is higher, and as the cosine similarity value approaches zero, the similarity between the two vectors can be lower.

The same or similar words may be placed adjacent to each other on the vector space in that the similarity between vectors is high as the cosine similarity value approaches 1.

Referring to FIG. 3, if “give,” “send,” “transfer,” and “pay” are identified as words having high similarity as the result of the learning of the AI model, the words “give,” “send,” “transfer,” and “pay” may exist at adjacent locations on the vector space. Specifically, “give,” “send,” “transfer,” and “pay” may exist in locations where cosine similarity is high. “Receive” and “get” may be identified as words having a high similarity and may exist at a location where the similarity is identified to be high, that is, to be adjacent on the vector space. However, “give,” “send,” “transfer,” and “pay” may be identified to have a low similarity with “receive” and “get,” and may exist in a space separate from “receive” and “get.”

As such, in that words with high similarity exist adjacent to each other on the vector space, the processor 120 may obtain a word that is similar in similarity to each word included in the input sentence from the database. Herein, the high similarity may denote that the intent of a word is the same or similar.

Returning to FIG. 2, the processor 120 may select at least one of the words stored in the database based on the vector value of the selected second word among the plurality of words included in the input sentence. Here, at least one word represents a word of which the cosine similarity with the vector value of the selected word is within a predetermined value, and may denote a word having the same or similar intent as the selected word.

The processor 120 may select a second word combinable with the first word among the plurality of words included in the input sentence. The processor 120 may select a second word that is combinable with the first word based on the intent of the input sentence.

The processor 120 may use the learned AI model to provide a sentence to search a plurality of candidate words that are combinable with the first word based on the intent of the input sentence, and may identify the degree of matching between each candidate word and the first word. Here, the degree of matching may probabilistically denote a value indicating the degree to which the intent of the sentence is maintained when the candidate word is combined with the first word.

The processor 120 may select a word that satisfies a predetermined condition with the first word as a second word combinable with the first word. For example, the processor 120 may select a word having the highest degree of matching among the candidate words, i.e., the word having the highest probability value for the first word as the combinable second word. This is only one embodiment, and a word having a probability value greater than or equal to a predetermined value may be set as a combinable second word.

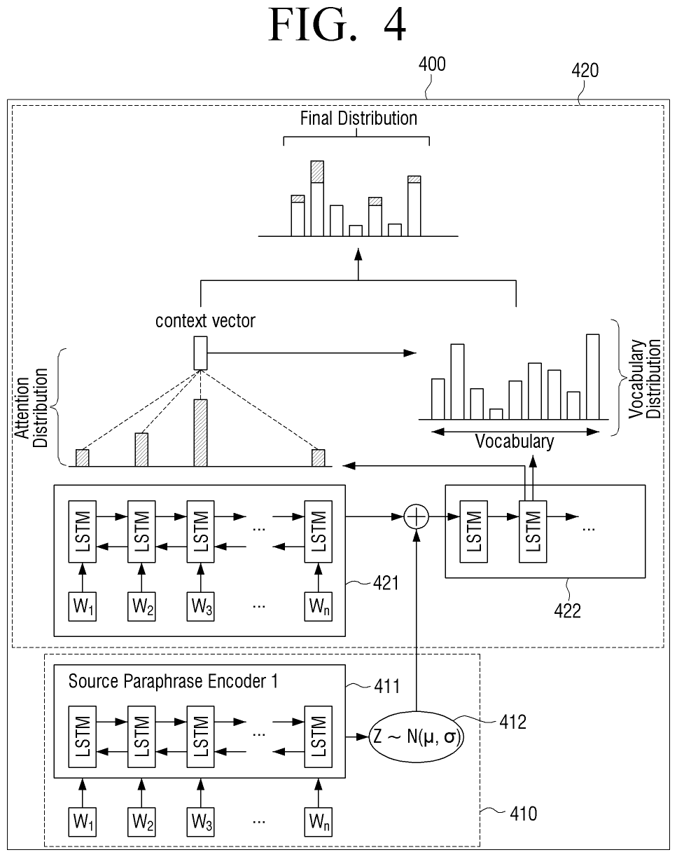

FIG. 4 illustrates an AI model for searching a plurality of words from database and selecting a combinable second word based on the degree of matching with the first word.

FIG. 4 is a diagram illustrating an artificial intelligence model included in an electronic apparatus according to an embodiment of the disclosure.

Referring to FIG. 4, the AI model included in the electronic apparatus 100 may include a diversity encoder 410 for generating various sentences of the sentence, and a content-preserving decoder 420 for intent preserving of the sentence.

The diversity encoder 410 may be implemented as a variational auto encoder (VAE) and the content-preserving decoder 420 may be implemented as a pointer generator network. That is, an AI model in this disclosure may be an AI model in which the variational auto encoder (VAE) and a pointer generator network are combined.

The diversity encoder 410 may include at least one encoder 411. The diversity encoder 410 may receive information about the input sentence and output a hidden state 412 of the encoder. The hidden state 412 denotes a potential variable for the input sentence, and the potential variable for the input sentence may be represented by a probability value that includes a feature for the input sentence. The potential variable output from the diversity encoder 410 may be input to the content-preserving decoder 420.

FIG. 4 illustrates that the diversity encoder 410 includes only one encoder 411, but the diversity encoder 410 may include a plurality of encoders. In this example, source sentence information and target sentence information may be input to the plurality of encoders, respectively, and the diversity encoder 410 may output a potential variable that commonly includes the feature of the source sentence information and the target sentence information. The diversity encoder 410 may identify that the feature commonly included in the two sentences as the features that should be maintained in a newly created sentence based on the source sentence information and the target sentence information, and may output a potential variable including the feature.

The content-preserving decoder 420 may include the encoder 421, the decoder 422, attention distribution, vocabulary distribution, and final distribution.

The encoder 421 of the content-preserving decoder 420 may be a module that reads words of the input sentence represented by the vector value into a word-by-word. The encoder 421 may include a bi-directional RNN considering a bi-directional order. The encoder 421 may output the hidden state of the encoder to the decoder 422 and the attention distribution.

The decoder 422 of the content-preserving decoder 420 may receive the hidden state output from the encoder 421 of the content-preserving decoder 420 and the potential variable of hidden state 412 output from the diversity encoder 410, and may output a result value in a form of a sequence of words included the sentence. The decoder 422 may include an RNN in one direction differently from the encoder.

The attention distribution may represent a probability for a word in the input sentence at a time operation that outputs a word in the decoder 422. The attention distribution may be a criterion that indicates which words among the plurality of words included in the input sentence should be noted at every time operation that the decoder intuitively outputs the word at the decoder. For example, at the time operation of outputting the second word at the decoder, if the value of the attention distribution corresponding to W3 has been higher, the decoder may preferentially consider the third word of the input sentence.

The vocabulary distribution may represent the distribution of words by combining the context vector obtained through the attention distribution and the output value of the hidden state of the decoder 422. The vocabulary distribution may be denoted as a probability (or weight) for the entire word at every operation of outputting a word by the decoder 422.

The final distribution is expressed based on the results of the attention distribution and the vocabulary distribution, and the most suitable word may be expressed through the final distribution. Here, the most suitable word may be the word having the highest probability value in the final distribution and may be the word having the highest degree of matching for the first word.

The processor 120 may select the second word combinable with the first word using the AI model described above.

The processor 120 may provide a plurality of sentences for the input sentence based on the first word and the second word. In the disclosure, a process of selecting only a second word is described, but a third word, a fourth word, or the like, included in the generated sentence may also be selected according to a process in which the second word is selected. Accordingly, the processor 120 may generate and provide a sentence that includes the same intent as the input sentence.

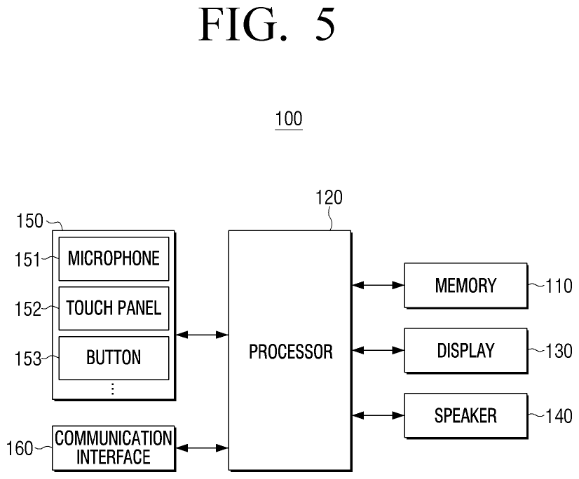

FIG. 5 is a block diagram illustrating a configuration of an electronic apparatus according to an embodiment of the disclosure.

Referring to FIG. 5, the electronic apparatus 100 may include the memory 110, the processor 120, a display 130, a speaker 140, an input interface 150, and a communication interface 160. Since the memory 110 and the processor 120 have been described with reference to FIG. 2, a detailed description thereof will be omitted.

The display 130 may display various information under the control of the processor 120. The display 130 may display a user interface (UI) for entering an input sentence and a UI for outputting or selecting a plurality of sentences having the same intent as the input sentence. The display 130 may be implemented as a touch screen with a touch panel 152.

The speaker 140 is configured to output various notification sounds or speech messages as well as various audio data in which various processing operations such as decoding, amplification, and noise filtering are performed by an audio processor. A configuration to output audio may be implemented as a speaker, and may be implemented as an output terminal for outputting audio data.

The input interface 150 may receive a user input for controlling the electronic apparatus 100. In particular, the input interface 150 may receive a user input for entering a particular sentence. As shown in FIG. 5, the input interface 150 may include a microphone 151 for receiving user voice, a touch panel 152 for receiving a user touch using a user's hand or a stylus pen, a button 153 for receiving a user manipulation, or the like. However, the input interface 150 shown in FIG. 5 is only one embodiment, and may be implemented as other input devices (e.g., keyboard, mouse, motion input, etc.)

The communication interface 160 may communicate with an external device. The communication interface 160 is configured to communicate with an external device. Communicating of the communication interface 160 with an external device may include communication via a third device (for example, a repeater, a hub, an access point, a server, a gateway, or the like). Wireless communication may include cellular communication using any one or any combination of the following, for example, long-term evolution (LTE), LTE advanced (LTE-A), a code division multiple access (CDMA), a wideband CDMA (WCDMA), and a universal mobile telecommunications system (UMTS), a wireless broadband (WiBro), or a global system for mobile communications (GSM), and the like. According to an embodiment, the wireless communication may include, for example, any one or any combination of Wi-Fi, Bluetooth, Bluetooth low energy (BLE), Zigbee, near field communication (NFC), magnetic secure transmission, radio frequency (RF), or body area network (BAN). Wired communication may include, for example, a universal serial bus (USB), a high definition multimedia interface (HDMI), a recommended standard 232 (RS-232), a power line communication, or a plain old telephone service (POTS). The network over which the wireless or wired communication is performed may include any one or any combination of a telecommunications network, for example, a computer network (for example, a local area network (LAN) or a wide area network (WAN)), the Internet, or a telephone network.

The communication interface 160 may communicate with an external electronic apparatus (not shown) to receive an input sentence from an external electronic apparatus (not shown), and when the same sentence as the input sentence is generated, the communication interface 160 may transmit the sentence to an external electronic apparatus (not shown).

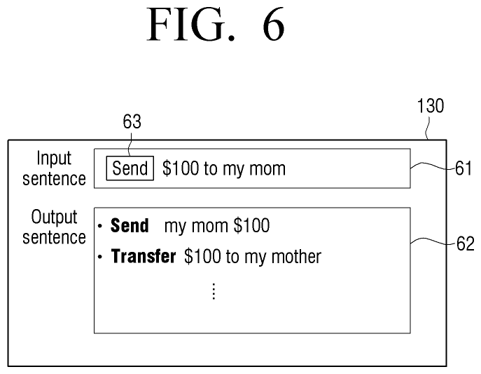

FIGS. 6 to 8 are diagrams illustrating an electronic apparatus according to various embodiments. FIGS. 6 to 8 illustrate a screen displayed on a display according to an embodiment, including an input sentence or a plurality of paraphrase sentences corresponding to the input sentence.

As illustrated in FIGS. 6 to 8, the processor 120 may control the display 130 to display a UI 61 for displaying an input sentence and a UI 62 for displaying a plurality of paraphrase sentences corresponding to the input sentence.

Based on a word selected by the user being present among a plurality of words included in the input sentence, the processor 120 may control the display 130 to distinguish the selected word from other words.

For example, as shown in FIGS. 6 to 8, the processor 120 may control the display 130 such that a highlight 63 is displayed in a selected one of the plurality of words included in the input sentence. Although only one word “send” among the plurality of words included in the input sentence is selected in FIGS. 6 to 8, two or more words included in the input sentence may be selected.

Although in the disclosure, the processor 120 is shown as displaying the highlight 63 in a selected one of a plurality of words included in the input sentence, but this is only one embodiment, and the processor 120 may change the color, size, and shape of the selected word to indicate that the selected word is distinguished from another word included in the input sentence.

The processor 120 may control the display 130 to display a word corresponding to the word selected in the input sentence among the plurality of words included in the plurality of suspect sentences having the same intent as the input sentence to be distinguished from another word.

FIG. 6 is a diagram illustrating an electronic apparatus according to an embodiment of the disclosure.

Referring to FIG. 6, the processor 120 may provide a plurality of sentences including an output sentence “send my mom $100,” and “transfer $100 to my mom” having the same intent as the input sentence “send $100 to my mom” using the AI model.

The processor 120 may select the synonym of the first word having the same intent as the first selected one of the words included in the input sentence, as described above in FIGS. 2 and 3, to provide an output sentence. For example, if “send” is selected among a plurality of words included in the input sentence, the processor 120 may select a word having the same text as “send” or having a different text but same intent word (e.g., “give,” “transfer,” etc.) in the database and may provide an output sentence.

In this example, the processor 120 may control the display 130 to display the synonyms of the first word having the same intent as the selected first word among the plurality of words included in the output sentence to be distinguished from the other remaining words. For example, the processor 120 may display words of “send,” “transfer” having the same intent as “send” of the input sentence among the plurality of sentences included in the output sentence as a bold face so as to be distinguished from other words of the output sentence. However, displaying the synonym of the first word as a bold type is an embodiment, and the processor 120 may display the synonym of the first word that has the same intent as the selected first word by changing the size, color, shape, etc. of the synonym of the first word to distinguish the synonym of the first word from other words.

As described above, in that the synonym includes at least one of the word having the same text with a specific word or a word having a different text but a same intent as a specific word, the processor 120 may generate a sentence including the word having the same text and intent as the first word of the input sentence or a sentence including a word having a different text with the first word of the input sentence but with a same intent.

The processor 120 may provide a sentence that includes words that have the same text as the first word selected in the input sentence according to the user's input or may provide a sentence that includes the word having the same intent as the selected first word. Here, a sentence including a word having the same intent as the selected first word may include a sentence including the same text as the selected first word.

For this purpose, the processor 120 may control the display 130, based on one of the plurality of words included in the input sentence being selected as the first word, to display a plurality of menus that indicate whether to provide a sentence including a word having a same text as the selected first word or a sentence including a word having a same intent as the selected first word.

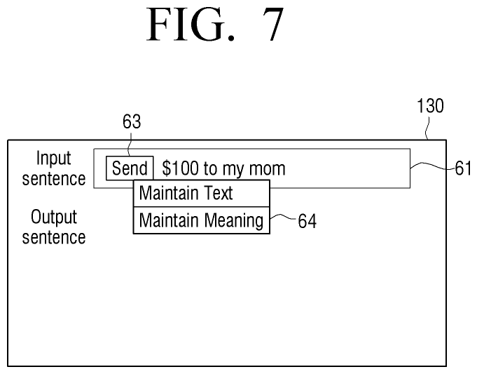

FIG. 7 is a diagram illustrating an electronic apparatus according to an embodiment of the disclosure.

Referring to FIG. 7, if the word “send” in the input sentence is selected as the first word, the processor 120 may control the display 130 to display a first menu (e.g., a Maintain Text menu) that provides a sentence that includes a word having the same text as the selected first word and a second menu 64 (e.g., Maintain Meaning) that provides a sentence including a word having the same intent as the selected first word.

If the first menu is selected, the processor 120 may provide a sentence that includes the word having the same text as the selected first word. When the first menu is selected, the processor 120 may select a second word combinable with the first word based on the intent of the input sentence, and combine the first word and the second word to generate an output sentence having the same intent as the input sentence.

If the second menu 64 is selected, the processor 120 may provide a sentence that includes a word having the same intent as the selected first word. When the second menu 64 is selected, the processor 120 may identify the word having the same intent as the selected first word as a word corresponding to the first word, select a second combinable with the word corresponding to the first word based on the intent of the input sentence, and combine the word corresponding to the first word with the second word to generate an output sentence having the same intent as the input sentence.

This is merely an embodiment, and the processor 120 may generate a plurality of output sentences including words that have the same intent as the first word selected as in the case where the second menu is selected, even if the first menu is selected, and may select and provide an output sentence that includes the word having the same text as the selected first word (i.e., the first word) selected from the plurality of generated sentences.

The processor 120 may store the plurality of generated output sentences in the memory 110 along with the input sentence. The processor 120 may associate an input sentence with an output sentence having the same intent as the input sentence and store the sentence in the memory 110.

The processor 120 may store only a part of the sentences selected by the user, among the plurality of generated output sentences, in the memory 110.

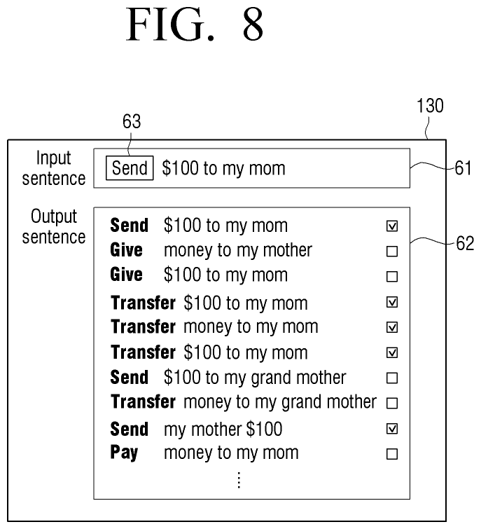

FIG. 8 is a diagram illustrating an electronic apparatus according to an embodiment of the disclosure.

Referring to FIG. 8, the processor 120 may receive a user input for selecting only some of the plurality of generated output sentences. For this purpose, when the processor 120 displays a plurality of sentences having the same intent as the input sentence on the display 130, the processor 120 may control the display 130 to display a UI 62 for selecting some of the plurality of sentences.

When the processor 120 receives a user input for selecting at least one of the plurality of sentences, the processor 120 may associate the selected sentence with the input sentence and store the sentence in the memory 110. The processor 120 may group the input sentence and the sentence selected by the user into sentences having the same intent and store the same in the memory 110.

The processor 120 may receive a user input for inputting a sentence that includes the same intent as the input sentence. After outputting the sentence having the same intent as the input sentence, the processor 120 may additionally receive a sentence having the same intent as the input sentence through the UI 62.

The processor 120 may store a sentence selected by the user among a plurality of sentences included in the output sentence and a sentence added by the user input together in the memory 110.

The processor 120 may retrain a learned artificial intelligence model 400 to provide a sentence of the same intent as the input sentence, based on at least one of an input sentence, a selected sentence, and an added sentence.

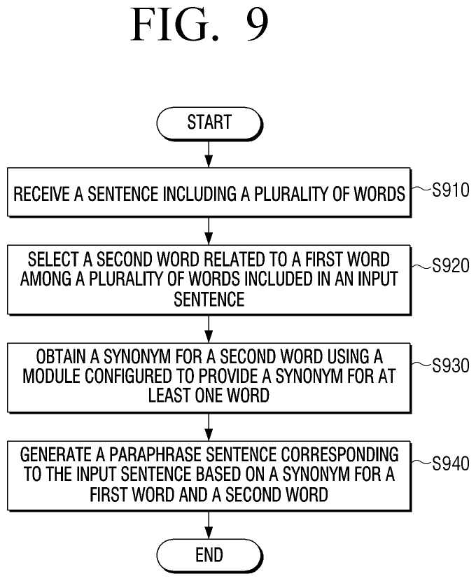

FIG. 9 is a flowchart illustrating a method for providing a sentence of an electronic apparatus according to an embodiment of the disclosure.

Referring to FIG. 9, the electronic apparatus 100 may receive a sentence including a plurality of words in operation S910. The electronic apparatus 100 may receive a sentence directly from a user, or may receive a sentence from another electronic apparatus. By executing an encoder included in the electronic apparatus 100, a potential variable for an input sentence may be generated. The potential variable for the input sentence represents a probability value that includes the feature of the input sentence and may correspond to the hidden state of the encoder. A decoder may be executed to generate an attention distribution including a weight of each of a plurality of words included in the input sentence. Here, the attention distribution represents a probability of a word of an input sentence in a time operation of outputting a word by a decoder. That is, the attention distribution may represent a weight of a plurality of words included in the input sentence at every time operation of outputting a word at the decoder.

The electronic apparatus 100 may select the second word associated with the first word among the plurality of words included in the inputted sentence in operation S920. The electronic apparatus 100 may select the first word to be included in the paraphrase sentence or a word corresponding to the first word. Here, the first word or the word corresponding to the first word may be a word selected by an encoder and a decoder. Alternatively, the first word may be a word selected by the user's selection.

If the electronic apparatus 100 receives a user input of selecting one of the plurality of words included in the input sentence as the first word, the electronic apparatus 100 may identify at least one word having the same intent as the first word selected by the user as the first word, and may select the second word based on the intent of the input sentence. The electronic apparatus 100 may select a word that is subsequent or combinable to the first word as the second word based on the attention distribution. The electronic apparatus 100 may select a word that is subsequent or combinable to the first word using the attention distribution at the time when the first word is identified and then a word subsequent or combinable to the first word is selected. For example, in a state in which “$100” is selected as the first word as the word to be included in the paraphrase sentence, the probability of “to my mother” among the words included in the input sentence is higher than the probability of “send” based on the attention distribution, and “to my mother” may be selected as the second word or text combinable with the first word.

Upon receiving a user input to select one of a plurality of words included in the input sentence as the first word, the electronic apparatus 100 may select a second word that is combinable with the first word based on the intent of the input sentence. The electronic apparatus 100 may perform natural language processing on the input sentence to determine the intent of the input sentence, and may select a second word combinable with the first word based on the determined intent of the input sentence. In order to select a second word combined with the first word while maintaining the intent of the input sentence, a trained AI model may be used to provide the same intent as the input sentence.

The electronic apparatus 100 may search for a plurality of candidate words combinable to the first word based on the intent of the input sentence, and determine a degree of matching between each candidate word and the first word.

The electronic apparatus 100 may select a word of which a matching degree with the first word satisfies a predetermined condition as the combinable second word. For example, the word with the highest matching degree among the candidate words, that is, the word with the highest probability value for the first word, may be selected as the second word. This is only one embodiment, and a word having a probability value greater than or equal to a predetermined value may be set to the second word.

The electronic apparatus 100 may obtain synonyms for the second word using a module configured to provide synonyms for at least one word in operation S930. The electronic apparatus 100 may obtain a vector value of the second word and obtain a synonym for the second word among the words stored in the database based on the obtained vector value. Here, the vector value is a numerical value of each word as a vector, and the more similar the vector value is, it can be determined that the vector value is semantically more similar.

In operation S940, the electronic device 100 may generate a paraphrase sentence corresponding to the input sentence based on the synonyms of the first word and the second word obtained in operation S930. The electronic apparatus 100 may receive a user input for selecting at least one of the generated paraphrase sentences, and the electronic apparatus 100 may associate the sentence selected by the user input with the input sentence and store the same.

The electronic apparatus 100 may display so that a word corresponding to the selected first word, among a plurality of words included in the plurality of provided sentences, is distinguished from another word.

The method of providing a sentence according to the disclosure may further include displaying an input sentence. In this example, if one of the plurality of words included in the input sentence is selected as the first word, a plurality of menus for the selected first word may be displayed. When the first menu among the plurality of menus is selected, a sentence including a word having the same text as the selected first word may be provided, and when the second menu among a plurality of menus is selected, a sentence including the same word including the word having the same intent as the selected first word may be provided.

Through the process as described above, a plurality of sentences having the same intent as the input sentence may be generated by combining the synonyms of the second word selected based on the intent of the input sentence and the word corresponding to the first word having the same intent as the selected first word among the plurality of words included in the input sentence.

The method for providing the sentence of the electronic apparatus 100 according to the embodiment described above may be implemented as a program and provided to the electronic apparatus 100. A program that includes a method for providing a sentence of the electronic apparatus 100 may be stored in a non-transitory computer readable medium.

Specifically, the method for providing a sentence of the electronic apparatus 100 may include receiving a sentence including a plurality of words; selecting a second word related to a first word among a plurality of words included in an input sentence; obtaining a synonym for the second word by using a module configured to provide the synonym for the at least one word; and generating a paraphrase sentence corresponding to the input sentence based on the synonym for the first word and the second word.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a ROM, and the like, and may be provided.

Although the embodiment has been briefly described with respect to a computer-readable recording medium comprising a program for executing a sentence providing method of the electronic apparatus 100 and a method for providing a sentence of the electronic apparatus 100, various embodiments of the electronic apparatus 100 may be applied to a computer-readable recording medium including a program for executing a sentence providing method of the electronic apparatus 100, and a method for providing a sentence of the electronic apparatus 100.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a memory storing a module configured to provide a synonym for at least one word included in an input sentence; and
a processor configured to:
generate, based on the input sentence including a plurality of words being input, at least one paraphrase sentence for the input sentence using the module,
select a second word related to a first word among the plurality of words included in the input sentence and obtain a synonym for the second word using the module, and
generate the at least one paraphrase sentence based on a synonym for the first word and the second word.

2. The electronic apparatus of claim 1,
wherein the memory comprises a database comprising a plurality of words, and
wherein the processor is further configured to:
in response to receiving a user input to select at least one word among a plurality of words included in the input sentence as a first word, select the second word combinable with the first word based on an intent of the input sentence, and
obtain a synonym for the second word using the module from the database stored in the memory.

3. The electronic apparatus of claim 2, wherein the processor is further configured to:
obtain a vector value of the second word, and
obtain a synonym for the second word among words stored in the database based on the obtained vector value.

4. The electronic apparatus of claim 1, wherein the processor is further configured to:
search a plurality of candidate words combinable with the first word based on an intent of the input sentence,
identify a degree of matching between the first word and the candidate word based on an attention distribution, and
select the second word based on the degree of matching.

5. The electronic apparatus of claim 1, wherein the processor is further configured to, based on receiving a user input to select at least one of the generated paraphrase sentences, store the selected at least one sentence in relation to the input sentence in the memory.

6. The electronic apparatus of claim 1, further comprising:
a display,
wherein the processor is further configured to:
display the input sentence, and based on one of a plurality of words included in the input sentence being selected as the first word, control the display to display a plurality of menus for the selected first word,
based on a first menu among the plurality of menus being selected, provide a paraphrase sentence including a word with a same text as the selected first word, and
based on a second menu among the plurality of menus being selected, provide a paraphrase sentence including a word with a same intent as the selected first word.

7. The electronic apparatus of claim 6, wherein the processor is further configured to control the display to display a word corresponding to the selected first word, among the plurality of words included in the provided paraphrase sentence, to be differentiated from another word.

8. A method of providing a sentence of an electronic apparatus, the method comprising:
receiving an input sentence including a plurality of words;
selecting a second word related to a first word among a plurality of words included in the input sentence;
obtaining a synonym for the second word using a module configured to provide a synonym for at least one word; and
generating one or more paraphrase sentences corresponding to the input sentence based on a synonym for the first word and the second word.

9. The method of claim 8, further comprising:
receiving a user input to select at least one word among a plurality of words included in the input sentence as a first word,
wherein the selecting of the second word comprises selecting the second word combinable with the first word based on an intent of the input sentence, and
wherein the obtaining of the synonym for the second word comprises obtaining the synonym for the second word by using the module from a database including a plurality of words.

10. The method of claim 9,
wherein the obtaining of the synonym for the second word comprises obtaining a vector value of the second word and obtaining a synonym for the second word among words stored in the database based on the obtained vector value.

11. The method of claim 8, wherein the selecting of the second word comprises:
searching a plurality of candidate words combinable with the first word based on an intent of the input sentence,
identifying a degree of matching between the first word and a candidate word based on an attention distribution, and
selecting the second word based on the degree of matching.

12. The method of claim 8, further comprising:
receiving a user input to select at least one of the generated one or more paraphrase sentences; and
storing the selected at least one paraphrase sentence in relation to the input sentence.

13. The method of claim 8, further comprising:
displaying the input sentence;
based on one of a plurality of words included in the input sentence being selected as the first word, displaying a plurality of menus for the selected first word;
based on a first menu among the plurality of menus being selected, providing a paraphrase sentence including a word with a same text as the selected first word; and
based on a second menu among the plurality of menus being selected, providing a paraphrase sentence including a word with a same intent as the selected first word.

14. The method of claim 13, further comprising:
displaying a word corresponding to the selected first word, among the plurality of words included in the provided paraphrase sentence, to be differentiated from another word.

15. A computer readable medium storing a program to execute a method of providing a sentence of an electronic apparatus, wherein the method for providing a sentence comprises:
receiving an input sentence including a plurality of words;
selecting a second word related to a first word among a plurality of words included in the input sentence;
obtaining a synonym for the second word using a module configured to provide a synonym for at least one word; and
generating a paraphrase sentence corresponding to the input sentence based on a synonym for the first word and the second word.
